(19) United States
(12) Patent Application Publication
(10) Pub. No.: US 2026/0081706 A1
(43) Pub. Date: Mar. 19, 2026

(54) SCHEDULE-BASED CHANNEL BONDING FOR DELIVERY OF MEDIA CONTENT

(71) Applicant: SONY GROUP CORPORATION, TOKYO (JP)

(72) Inventors: GRAHAM A CLIFT, POWAY, CA (US); ADAM GOLDBERG, FAIRFAX, VA (US); LUKE FAY, SAN DIEGO, CA (US); FRED W ANSFIELD, SAN DIEGO, CA (US)

(21) Appl. No.: 18/884,814

(22) Filed: Sep. 13, 2024

(51) Int. Cl. H04H 60/06; H04H 60/90

(52) U.S. Cl. CPC H04H 60/06; H04H 60/90

(57) ABSTRACT

An electronic device and a method for implementation for schedule-based channel bonding for delivery of media content. The system determines a schedule of delivery of a media file to a plurality of receiver devices that are within a coverage area of the broadcast station. The system broadcasts, over a signal, signaling information that includes the schedule to the plurality of receiver devices. The system performs, based on the signaling information, a channel bonding operation to combine a plurality of radio channels into a bonded channel, wherein the plurality of radio channels is associated with one or more radio transmission spectrums. The system transmits the media file to the plurality of receiver devices over the bonded channel, based on the schedule.

### CROSS-REFERENCE TO RELATED APPLICATIONS/INCORPORATION BY REFERENCE

None.

### FIELD

Various embodiments of the disclosure relate to channel bonding and digital transmission. More specifically, various embodiments of the disclosure relate to an electronic device and method for schedule-based channel bonding for delivery of media content.

### BACKGROUND

Channel bonding is a well-known technique in the field of data communication, which involves combining two or more channels to create a larger data pipe for transmitting data. The technique is particularly useful in scenarios where high data rates are desired, such as in the delivery of high-definition media content. One of the standards that support channel bonding is the Advanced Television Systems Committee (ATSC) 3.0. ATSC 3.0 is a suite of standards that define the transmission and reception of terrestrial television broadcasting. It includes provisions for channel bonding, allowing broadcasters to combine multiple channels to increase the data rate for delivering media content. However, the use of channel bonding in ATSC 3.0 presents some challenges. For instance, it requires a high signal-to-noise ratio (SNR) to achieve the maximum data payload. This may be impractical in real-world scenarios where the SNR may not be consistently high. Furthermore, the standard's provisions for channel bonding are limited to two channels, which may not be sufficient for delivering large files, such as 4K television content.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for schedule-based channel bonding for delivery of media content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for schedule-based channel bonding for delivery of media content, in accordance with an embodiment of the disclosure.

FIG. 2 is a block diagram that illustrates an exemplary system of FIG. 1, in accordance with an embodiment of the disclosure.

FIG. 3 is a diagram that illustrates an exemplary processing pipeline for schedule-based channel bonding for delivery of media content, in accordance with an embodiment of the disclosure.

FIG. 4 is a diagram that illustrates an exemplary scenario of schedule for delivery of media content based on the broadcasted schedule, in accordance with an embodiment of the disclosure.

FIG. 5 is a flowchart that illustrates operations of an exemplary method for schedule-based channel bonding for delivery of media content, in accordance with an embodiment of the disclosure.

### DETAILED DESCRIPTION

The following described implementation may be found in a system and method for schedule-based channel bonding for delivery of media content. Exemplary aspects of the disclosure may provide a system that may determine a schedule of delivery of a media file to a plurality of receiver devices that are within a coverage area of the broadcast station. Next, the system may broadcast, over a signal, signaling information that includes the schedule to the plurality of receiver devices. Thereafter, the system may perform, based on the signaling information, a channel bonding operation to combine a plurality of radio channels into a bonded channel, wherein the plurality of radio channels is associated with one or more radio transmission spectrums, further the system may transmit the media file to the plurality of receiver devices over the bonded channel, based on the schedule.

In some aspects, the system may determine a schedule for the delivery of a media file to a plurality of receiver devices within a coverage area of a broadcast station. The system may then broadcast signaling information, which includes the schedule, to the receiver devices. Based on this signaling information, the system may perform a channel bonding operation to combine multiple radio channels into a bonded channel. These radio channels may be associated with one or more radio transmission spectrums. The media file may be then transmitted to the receiver devices over the bonded channel, according to the schedule.

In the context of Advanced Television Systems Committee (ATSC) 3.0, the system may add flexibility to high-data-rate delivery, creating on-demand high-bandwidth pipes. This may result in better spectrum usage by combining two or more transmissions in different frequencies or spectrums, such as an ATSC 3.0 transmission and an unlicensed transmission, into a combined higher-data-rate pipe.

The disclosure may provide channel bonding based on a schedule time and using signaling information broadcasted over a signal by a broadcast station to receiver devices (such as televisions). Further, the system may combine two or more radio transmission spectrum to configure high bandwidth on demand for a high data rate. Two or more radio transmission spectrum may be associated with plurality of spectrum (such as, Advanced Television Systems Committee (ATSC) 3.0 spectrum, Internet of things (IOT) spectrum, or Wi-Fi spectrum). Also, there may be a combination of licensed and unlicensed spectrum to provide high data rate for transmission and reception of the data. Therefore, the system may provide on demand channel bonding.

The disclosure addresses the limitations of ATSC 3.0, which supports channel bonding but requires a high signal-to-noise ratio for maximum data payload. The proposed solution involves using channel bonding selectively during off-peak hours to deliver large files, such as 4K television content or data for city government use, and then reverting to regular programming. The disclosure also provides flexibility in the use of different radio transmission spectrums, potentially including both licensed and unlicensed spectrums. Furthermore, the use of signaling information to communicate the schedule and channel bonding information to receiver devices may facilitate the efficient and effective reception of the transmitted media files.

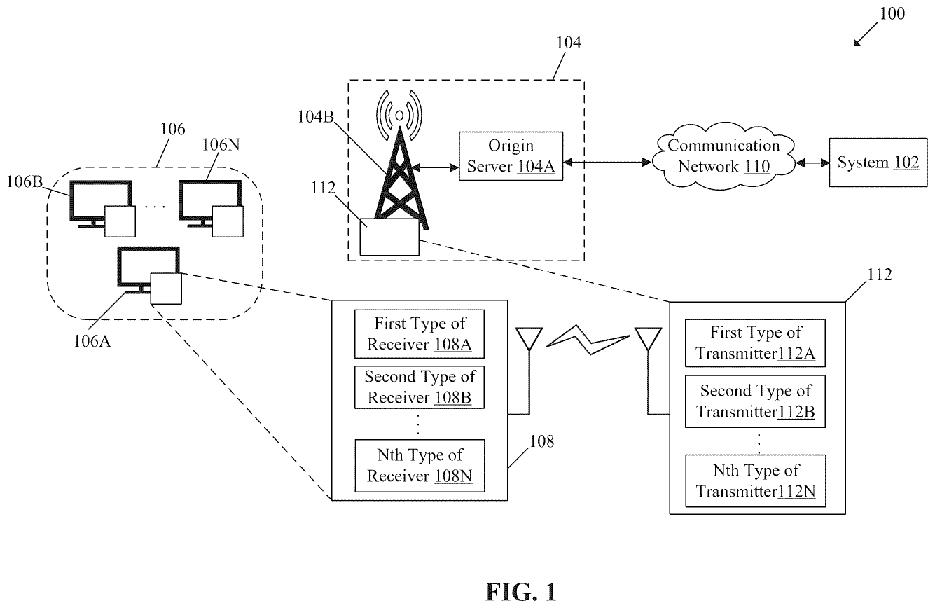

FIG. 1 is a block diagram that illustrates an exemplary network environment for schedule-based channel bonding for delivery of the media content, in accordance with an embodiment of the disclosure. With reference to FIG. 1, there is shown a network environment 100. The network environment 100 may include a system 102, a broadcast station 104, a plurality of receiver devices 106A, 106B . . . 106N (also, collectively referred to as plurality of receiver devices 106, herein), and a communication network 110. The broadcast station 104 may include an origin server 104A, a broadcast tower 104B, and a plurality of transmitters 112A, 112B . . . 112N (also, collectively referred to as a plurality of transmitters 112, herein). The plurality of transmitters 112 may support wireless transmission over different wireless communication protocols or transmission spectrums. Further, each receiver device of the plurality of receiver devices 106A, 106B . . . 106N may be associated with a tuner 108 that may support wireless reception over a specific wireless communication protocol or a wireless spectrum.

The system 102 may include suitable logic, circuitry, interfaces, and/or code that may be configured to execute a set of operations that include a determination of a schedule for a delivery of media content, a generation of signaling information with the schedule, an execution of a channel bonding operation to generate a high-data rate pipe for the delivery, and a transmission (or a broadcast) of the media content over a bonded channel to the plurality of receiver devices 106 within a coverage area of the broadcast station 104.

In accordance with an embodiment, the system 102 may include one or more servers to encode and package the media content to prepare a transport media stream. The media content and the signaling information may be transmitted to various receiver devices (e.g., the plurality of receiver devices 106 of FIG. 1) as in-band data included with the transport media stream or as out-of-band data (which may be separate from the transport media stream). In case the system 102 supports ATSC 3.0 transmission, the media content and/or the signaling information may be delivered simultaneously through the Internet and Over-the-Air (OTA) radio signals. For example, the origin server 104A may serve segments to be delivered OTA and through a content delivery network (CDN). This way, viewers with internet connections may receive personalized programming and advertisements while others may receive the OTA signal.

Example implementations of the system 102 may include, but are not limited to, a mainframe machine, a server (such as a cloud server), a cluster of servers, a Fog computing system, a decentralized network such as a Blockchain, an edge device, a computer workstation, and a transmission equipment, a content delivery network, an Advanced Television System Committee (ATSC) or Society of Cable Telecommunications Engineers (SCTE) content broadcast network, an ATSC, SCTE or Digital Video Broadcasting (DVB) delivery and signaling server, a broadcast gateway, or a combination thereof. In an exemplary embodiment, the system 102 may be implemented as a server or a cluster of servers other than the origin server 104A.

In accordance with an embodiment, the system 102 may include a delivery sub-system and a transmission sub-system. The delivery sub-system may include at least one of content encoder(s), transcoder(s), packaging server(s), signaling server(s), broadcast gateway(s), Electronic Service Guide (ESG) server(s), NRT (Non-Real-Time) server(s), CDN, Ad server(s), and the like. The transmission sub-system may include at least one of digital exciter(s) (such as an ATSC, SCTE, or DVB exciter), a broadcast hardware, a transmitter station, and the like. Further details of such sub-system(s) are omitted from the disclosure for the sake of brevity.

The broadcast station 104 may refer to a set of equipment managed by a business, organization, or other entity that transmits media content via terrestrial signals or satellite signals. The media content may include shows, movies, news, and other forms of content. In accordance with an embodiment, the broadcast station 104 may transmit the media content via a plurality of radio channels to the plurality of receiver devices 106 in the coverage area. As an example, the broadcast station 104 may be a television station for a terrestrial or satellite broadcast of the media content. In case of the television station, a television transmission may occur via analog television signals, or more commonly, via digital television signals (such as ATSC 1.0, ATSC 2.0, or ATSC 3.0 signals). ATSC 3.0 may facilitate a simultaneous distribution over the internet as well as over the air (OTA).

In FIG. 1, the system 102 and the broadcast station 104 are shown as two separate entities. However, the present disclosure may not be so limiting and in some embodiments, the broadcast station 104 may be a part of the system 102 in its entirety or at least partially, without a departure from the scope of the present disclosure.

In accordance with an embodiment, the broadcast station 104 may include the origin server 104A and the broadcast tower 104B that hosts the plurality of transmitters 112A . . . 112N. A person of ordinary skill in the art will understand that the broadcast station 104 may also include other suitable components or systems, in addition to the components or systems which are illustrated herein to describe and explain the function and operation of the present disclosure. A detailed description of the other components or systems of the broadcast station 104 has been omitted from the disclosure for the sake of brevity.

In an embedment, the broadcast station 104 associated with the origin server 104A may broadcast the signaling information to the plurality of receiver devices 106. The one or more receiver devices 106 may be selected from the receiver devices 106A,106-B . . . 106N. Each receiver device from the plurality of receiver devices 106 may include at least of tuner 108 with at least one antenna. Here, the signaling information includes various information such as, a time stamp, a file name, a URL, a schedule, channel bonding information, and the likes. Each receiver device from the plurality of receiver devices 106 may further receive the signal with signaling information that configures the tuner 108 associated with the respective receiver device to support a plurality of radio channels combined due to the channel boding. Further, each receiver device from the plurality of the receiver devices 106 may control the configured tuner 108 to receive the media file over the bonded channel.

The origin server 104A in ATSC (particularly in the context of ATSC 3.0) may hold, in Over The Top (OTT) broadcasting, a video collection, temporarily storing the content on a disk and may respond to requests from the CDNs. In accordance with an embodiment, the origin server 104A may be a part of the system 102 that runs its software elements close to the channel origination while having a minimal footprint on premises. In an embodiment, the origin server 104A may wait for an incoming request from the system 102 or the plurality of receiver devices 106 and may respond to the incoming request with an original version of requested data.

In at least one embodiment, the origin server 104A may be implemented as a cloud server and may execute operations through web applications, cloud applications, HTTP requests, repository operations, file transfer, and the like. Other example implementations of the origin server 104A may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the origin server 104A may be implemented as a plurality of distributed cloud-based resources by use of several technologies that are well known to those ordinarily skilled in the art. A person with ordinary skill in the art will understand that the scope of the disclosure may not be limited to the implementation of the origin server 104A and the system 102, as two separate entities. In certain embodiments, the functionalities of the origin server 104A may be incorporated in its entirety or at least partially in the system 102 without a departure from the scope of the disclosure. In certain embodiments, the origin server 104A may host the database.

The broadcast tower 104B may refer to a physical structure used for transmitting a range of communication services including radio and television. The broadcast tower 104B may either act as an antenna itself or may support one or more antennas on its structure, including microwave dishes. These towers may be typically tall structures designed to support antennas for telecommunications and broadcasting. In accordance with an embodiment, the broadcast tower 104B may support the plurality of transmitters 112A . . . 112N.

Each receiver device of the plurality of receiver devices 106 may include suitable logic, circuitry, interfaces, and/or code that may be configured to receive, via radio signals transmitted by the broadcast station 104 and/or via the Internet, the media content and the signaling information associated with the transmission of the media content. The signaling information may enable broadcasters to define service descriptions as well as service icons to maximize promotion of their service. In case the signaling information pertains to ATSC 3.0 signaling, the signaling information may refer to the technical mechanisms and procedures pertaining to service signaling and IP-based delivery of a variety of ATSC X (where X may be 2.0, 3.0, or later version of services and contents to ATSC-capable receivers over broadcast, broadband, and hybrid broadcast/broadband networks.

In accordance with an embodiment, each of the plurality of receiver devices 106 may be a display device (for example, a television) or a media player that includes one or more integrated tuners for digital signals. In accordance with another embodiment, each receiver device of the plurality of receiver devices 106 may be a tuner or a set-top-box that may be communicatively coupled to a display device. In accordance with another embodiment, the receiver device may be a single carrier receiver that derives selectivity in the analog filters of the IF stages or may support multiple transmission standards as a multi-carrier receiver.

By way of example, and not limitation, each receiver device of the plurality of receiver devices 106 may be an ATSC receiver that is equipped with an ATSC tuner. The tuner may allow the receiver device to receive and decode digital television (DTV) broadcast signals transmitted using ATSC standards. These standards are used for digital television transmission over terrestrial, cable, and satellite networks. The ATSC tuner may enable the TV to display high-definition images and multiple channels of information carried on a single stream.

In an embodiment, each receiver device of the plurality of receiver devices 106 may configure one or more tuners that support a plurality of radio channels associated with one or more transmission spectrums. The receiver device 106A may be configured to control the configured one or more tuners to receive the media file over a bonded channel. Examples of the plurality of receiver devices 106 may include, but are not limited to, a smartphone, a media player, a mobile phone, a wearable display, a gaming device, a set-top-box, a DTV tuner, a television, a mainframe machine, a server, or a computer workstation.

In an embodiment, the plurality of receiver devices 106 may be configured to receive the media file transmitted by the system 102 over the bonded channel based on a schedule specified in the signaling information received by the plurality of receiver devices 106. Further, each receiver device of the plurality of the receiver devices 106 may include at least one tuner (e.g., the tuner 108) and RF circuits that support one or more transmission spectrums. In another embodiment, each receiver device of the plurality of the receiver devices 106 may retrieve the media file from the origin server 104A over the bonded channel or via a channel associated with the one or more radio transmission spectrums.

The tuner 108 may include suitable logic, circuitry, interfaces, and/or code configured to perform multiple functions related to signal reception and processing. In some aspects, the tuner 108 may be capable of receiving and demodulating signals that contain signaling information. The tuner 108 may also be adaptable to support various radio channels, with its configuration potentially based on scheduling details provided in the received signaling information. Additionally, the tuner 108 may be equipped to receive and process media files transmitted over a bonded channel, which may be formed by combining multiple radio channels. In some cases, the tuner 108 may dynamically adjust its operating parameters to optimize reception based on the current transmission mode, whether it involves individual channels or a bonded channel configuration.

In an embodiment, the tuner 108 may include at least one antenna and one or more types of receivers such as, a first type of receiver 108A, a second type of receiver 108B, and an Nth type of receiver 108N. For example, the tuner 108 may include one or more types of receivers for different broadcast standards.

In some aspects, the tuner 108 may incorporate at least one antenna and multiple types of receivers to accommodate various broadcast standards and transmission modes. These receivers may include, but are not limited to, a first type of receiver 108A, a second type of receiver 108B, and an Nth type of receiver 108N. Each type of receiver may be designed to handle specific broadcast standards or frequency ranges, allowing the tuner 108 to support a wide array of radio channels and transmission protocols.

For instance, the first type of receiver 108A may be optimized for Advanced Television Systems Committee (ATSC) 3.0 broadcasts, while the second type of receiver 108B may be tailored for Wi-Fi, Telecom, or IoT Broadcast Standards. The Nth type of receiver 108N may be capable of handling emerging or specialized broadcast standards or unlicensed spectrums, ensuring the tuner's adaptability to future technological advancements.

In some cases, the tuner 108 may dynamically switch between these different types of receivers based on the received signaling information and a current channel bonding configuration. This flexibility allows the tuner 108 to efficiently process signals from various sources and adapt to changing broadcast conditions, thereby enhancing its overall performance and versatility in receiving media files over bonded channels.

The communication network 110 may include a communication medium through which the system 102 and the origin server 104A may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5^{th} Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The plurality of transmitters 112 may include suitable logic, circuitry, interfaces, and/or code that may be configured to perform various functions related to media file delivery and channel bonding. The plurality of transmitters 112 may be capable of determining an optimal schedule for delivering media files to the plurality of receiver devices 106 within the coverage area of the broadcast station 104. This scheduling process may consider factors such as network traffic, available bandwidth, and receiver device capabilities.

The plurality of transmitters 112 may broadcast signaling information, which includes the delivery schedule, over a signal to the plurality of receiver devices 106. This signaling information may be encoded and modulated to ensure reliable transmission across various channel conditions. Based on this signaling information, the plurality of transmitters 112 may execute a channel bonding operation, combining multiple radio channels into a single bonded channel. The radio channels used in this operation may be associated with one or more radio transmission spectrums, potentially including both licensed and unlicensed spectrums.

Once the bonded channel is established, the plurality of transmitters 112 may transmit the media file to the receiver devices 106 based on the predetermined schedule. This transmission may utilize advanced error correction and adaptive modulation techniques to ensure efficient and reliable delivery of the media file over the bonded channel.

Each transmitter of the plurality of transmitters 112 may take various forms, including but not limited to, a dedicated broadcasting device, a multi-purpose computing device, or a specialized communication system. Examples may include a high-performance server, a software-defined radio system, an ATSC 3.0 compliant transmitter, or an advanced IoT gateway. In some cases, each transmitter may incorporate machine learning capabilities to optimize its performance based on historical transmission data and current network conditions.

In some embodiments, the plurality of transmitters 112 may include multiple types of transmitters (as shown, for example, transmitters 112A, 112B . . . 112N), each optimized for different transmission spectrums or protocols. For instance, the first type of transmitter 112A may be specifically configured to broadcast over the ATSC spectrum, utilizing the advanced features of the ATSC 3.0 standard such as Orthogonal frequency-division multiplexing (OFDM) modulation and low-density parity-check (LDPC) coding. The second type of transmitter 112B may be designed to operate in the IoT spectrum, potentially using protocols such as LoRaWAN or NB-IoT for efficient, long-range transmission of data to IoT devices. This multi-transmitter configuration may allow for greater flexibility in channel bonding operations, potentially combining channels from different spectrums to create high-bandwidth pipes for data transmission. It may also enable the system 102 to adapt to varying regulatory requirements and spectrum availability across different regions or time periods.

In operation, the system 102 may determine a schedule for delivering a media file to the plurality of receiver devices 106 within the broadcast station's coverage area. This schedule may be based on an agreement between the system 102, including the broadcast station 104, and the plurality of receiver devices 106. The agreement may specify dates, times, and processes for media file delivery. The broadcast station's coverage area may correspond to its service area.

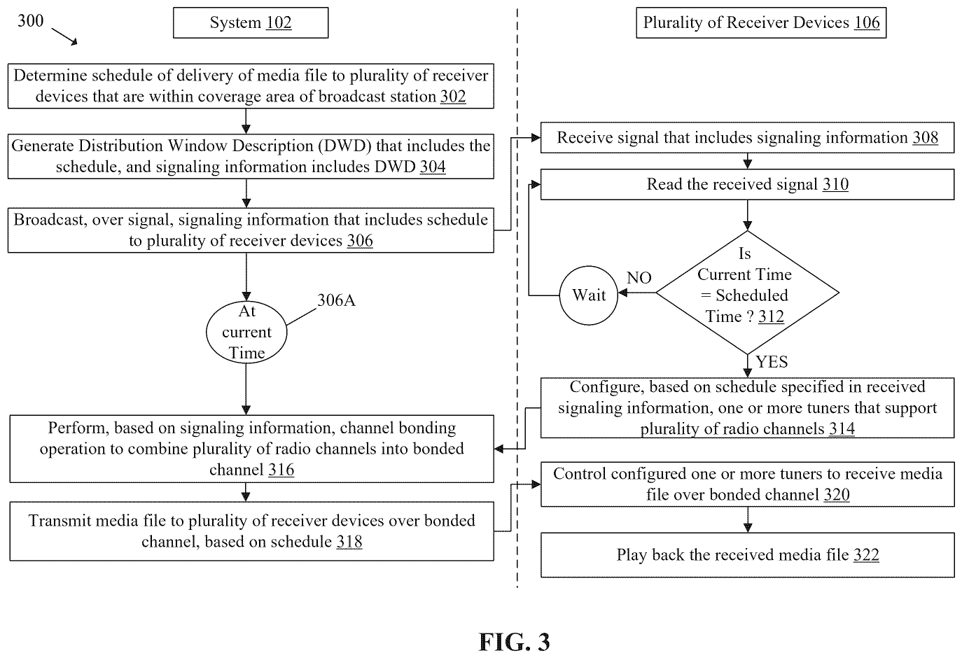

The schedule may be included in a Distribution Window Description (DWD), which may detail time periods and intervals when the media file is available to users. The system 102 may generate the DWD based on information about the media file's distribution and availability through various radio channels over time. Further details about the delivery schedule are described in FIG. 3 (302 and 304).

The system 102 may broadcast signaling information, including the schedule, to the plurality of receiver devices 106. This signaling information may also include a Uniform Resource Locator (URL) for the origin server 104A storing the media file. Additional information about the delivery schedule is provided in FIG. 3.

After the broadcast of the signaling information, a channel bonding operation may be performed. In an embodiment, the system 102 may perform the channel bonding operation based on the signaling information. The signaling information may include details about the radio channels to be combined and a configuration of the bonded channel. This operation may involve combining multiple radio channels into a single, larger channel, known as a bonded channel, effectively creating a high data rate pipe. The radio channels that may be combined in this operation are associated with one or more radio transmission spectrums, which may be licensed or unlicensed. Examples include the Advanced Television Systems Committee (ATSC) spectrum, Wi-Fi frequency bands, or Narrowband-Internet of Things (NB-IoT) bands.

The system 102 may then transmit the media file to the plurality of receiver devices 106 over the bonded channel, based on the determined schedule. In some embodiments, the transmission may involve splitting media file traffic at the packet level among these channels. The bonding process may combine the media file according to the requirements of the plurality of receiver devices 106. Further details about this transmission process are described in FIG. 3 (320).

On the receiver side, the plurality of receiver devices 106 may retrieve the media file from the origin server 104A. This retrieval can be done over the bonded channel or via a channel associated with one or more radio transmission spectrums. The plurality of receiver devices 106 may be equipped with tuners (e.g., the tuner 108) that may be configured to receive signals from the bonded channel or the associated radio transmission spectrums. This configuration may be based on the signaling information.

Overall, the operational process allows for efficient and flexible high-data-rate delivery of media files. By leveraging channel bonding and scheduling techniques, the system 102 associated with the broadcast station 104 may optimize the use of available bandwidth and ensure the smooth delivery of media files to the plurality of receiver devices 106. This process may also provide flexibility in the use of different radio transmission spectrums, potentially including both licensed and unlicensed spectrums.

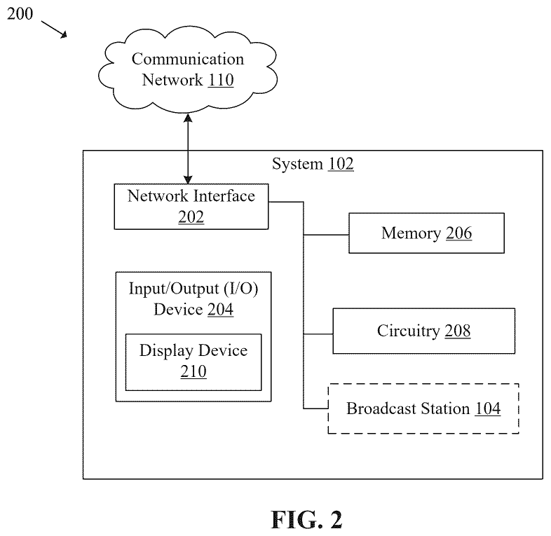

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the exemplary system 102. The system 102 may include a network interface 202, an input/output (I/O) device 204, a memory 206, circuitry 208, and the broadcast station 104. The memory 206 may store the delivery schedules. The input/output (I/O) device 204 may include a display device 210.

The network interface 202 may include suitable logic, circuitry, interfaces, and/or code that may be configured to facilitate communication between the broadcast station 104 and the system 102, via the communication network 110. The network interface 202 may be implemented by use of various known technologies to support wired or wireless communication of the broadcast station 104 with the communication network 110. The network interface 202 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 202 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The I/O device 204 may include suitable logic, circuitry, interfaces, and/or code that may be configured to receive an input and provide an output based on the received input The I/O device 204 may be further configured render and display the determined schedule of delivery of the media file. Furthermore, the I/O device 204 may be further configured render and display the bonded channel over which the media file may be transmitted. The I/O device 204 may include the display device 210. Examples of the I/O device 204 may include, but are not limited to, a display (e.g., a touch screen), a keyboard, a mouse, a joystick, a microphone, or a speaker. Examples of the I/O device 204 may further include braille I/O devices, such as, braille keyboards and braille readers.

The memory 206 may include suitable logic, circuitry, interfaces, and/or code that may be configured to store one or more instructions to be executed by the circuitry 208. The one or more instructions stored in the memory 206 may be configured to execute the different operations of the circuitry 208. The memory 206 may be further configured to store the schedule of delivery of the media file to the plurality of receiver devices 106. Examples of implementation of the memory 206 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The circuitry 208 may include suitable logic, circuitry, and/or interfaces that may be configured to execute program instructions associated with different operations to be executed by the system 102. The operations may include, for example, the schedule of delivery of the media files determination, the signal information broadcasting, the channel bonding operation performance, media file transmission, and the like. The circuitry 208 may include one or more processing units, which may be implemented as a separate processor. In an embodiment, the one or more processing units may be implemented as an integrated processor or a cluster of processors (on the same or different devices) that perform the functions of the one or more specialized processing units, collectively. The circuitry 208 may be implemented based on a number of processor technologies known in the art. Examples of implementations of the circuitry 208 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The display device 210 may include suitable logic, circuitry, and interfaces that may be configured to display the changes in the schedule of delivery of the media file to the plurality of receiver devices 106 that may be within the coverage area of the broadcast station 104. The display device 210 may be a touch screen which may enable a user to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display.

FIG. 3 is a diagram that illustrates an exemplary processing pipeline for schedule-based channel bonding for delivery of media content, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 322 for implementation of schedule-based channel bonding for delivery of media content. The exemplary operations 302 to 322 may be executed by any computing system, for example, by the system 102 of FIG. 1 or by the circuitry 208 of FIG. 2.

At 302, an operation for delivery schedule determination may be executed. The circuitry 208 may be configured to determine a schedule of delivery of the media file to the plurality of receiver devices 106. The plurality of receiver devices 106 for which the delivery schedule may be determined are within the coverage area of broadcast station 104. The delivery schedule may be obtained based on user input or may be obtained by the system 102. Examples of the schedule may include, but are not limited to, a date and time along with the process of delivery and the like. Examples of the media file associated with the scheduled delivery may include, but are not limited to, a video, an audio file, an image, or a combination thereof.

In an embodiment, the media file may correspond to an audio/video file. The audio/video file may be associated with broadcasting from a television broadcast station of the system 102. The audio/video file may be broadcasted to the plurality of receiver devices 106, which may be within the coverage area of the television broadcast station (for example, the broadcast station 104 in FIG. 1).

In some aspects, the television broadcast station may broadcast various radio channels associated with one or more radio transmission spectrums. For example, the television broadcast station of the system 102 may broadcast using at least one of the ATSC spectrum, the Wi-Fi frequency band, or the NB-IoT band.

In some cases, the plurality of receiver devices 106 may be a plurality of televisions. The video/audio file may be scheduled for delivery to such televisions. Furthermore, the television broadcast station of the system 102 may be configured to determine the schedule (for example, 11 PM) to deliver the video/audio file to the plurality of televisions within the coverage area of the television broadcast station.

In an embodiment, the media file may correspond to an audio file. The audio file may be associated with broadcasting from a radio station of the system 102. The audio file may be broadcasted to the plurality of receiver devices 106, which may be within the coverage area of the radio station. In some aspects, the radio station may broadcast various radio channels associated with one or more radio transmission spectrums. For example, the radio station of the system 102 may broadcast using at least one of the radio spectrum, the ATSC spectrum, the Wi-Fi frequency band, or the NB-IoT band. In some cases, the plurality of receiver devices 106 may be a plurality of radio devices. The audio file may be scheduled for delivery to such radio devices. Furthermore, the radio station of the system 102 may be configured to determine the schedule (for example, 12 PM) to deliver the audio file to the plurality of radio devices within the coverage area of the radio station.

At 304, an operation for DWD generation may be executed. The circuitry 208 may be configured to generate a DWD that includes the schedule for delivery of the media file. The DWD may be included in the signaling information that may be shared with the plurality of receiver devices 106. The signaling information may further include a Uniform Resource Locator (URL) to the origin server 104A that stores the media file. In some aspects, the generated DWD may include at least one instance of a Distribution Window element. The DWD may include information about one or more media files scheduled for transmission from the system 102 to the plurality of receiver devices 106. The media file may refer to a combination of various data files, such as video, audio, images, or documents. In some cases, the signaling information may include the generated DWD. The DWD may further include a start time and an end time of the distribution window, along with information about the plurality of radio channels and a plurality of media file identifiers.

At 306, an operation for signaling information broadcasting may be executed. The circuitry 208 may be configured to broadcast, over the signal, the signaling information that includes the schedule to the plurality of receiver devices 106. The signaling information may include the DWD, which contains the schedule for the media file delivery. The circuitry 208 may broadcast this signaling information to the plurality of receiver devices 106 over the signal.

In some aspects, the signaling information may correspond to the generated DWD that contains a distribution window instance with a plurality of attribute values. These attribute values may include labels for various time intervals. The broadcast station 104 may use these distribution windows to broadcast multiple media files. In some cases, the receiver devices 106 may be configured to avoid participating in the delivery of distribution windows that contain media files they have already received.

In some embodiments, the schedule in the signaling information may correspond to a specific time, such as 5 PM. The receiver devices 106 may be televisions, and the broadcast station 104 may be a television broadcast station. The DWD may be generated with a schedule for delivering the media file to one or more of the televisions at the specified time (e.g., 5 PM). The selection of which televisions receive the media file may be based on user input or determined by the circuitry 208. This DWD, including the 5 PM schedule, may be incorporated into the signaling information for further processing.

The system 102 may provide flexibility in scheduling and delivering media files to various types of receiver devices. For example, it may accommodate different broadcast scenarios, such as delivering audio/video files to televisions or audio files to radio devices. This adaptability allows the system 102 to efficiently manage the distribution of media content across different platforms and device types.

At 308, an operation for signal reception may be executed. Each receiver device of the plurality of receiver devices 106 may receive the signal that includes the signaling information. The signal received by each of the plurality of receiver devices 106 may be the signal broadcasted by the broadcast station 104. In some aspects, the signaling information may include the DWD with the specified schedule. In some cases, the signaling information may further include the URL to the origin server 104A where the media file may be stored.

At 310, an operation for received signal reading may be executed. Each receiver device may read the received signal that includes signaling information. In some aspects, each receiver device may determine the DWD and the schedule included in the signaling information.

At 312, it may be checked whether current time 306A is equal to the scheduled time. The scheduled time may be denoted by “ST” and the current time 306A may be denoted by “T”. The circuitry 208 may determine whether the current time 306A (“T”) is equal to the scheduled time “ST” upon reading the received signal. The condition for checking may be defined as follows: When T is not equal to ST, the system 102 may pass the signal to a clock. The clock may be a counter with a specified time delay. The system 102 may wait for the counter to expire before reading the received signal again and repeating the check. When T is equal to ST, the system 102 may proceed to 314.

In some aspects, this time-checking mechanism may ensure that the system 102 synchronizes its operations with the scheduled time for media file delivery. The use of a clock with a specified time delay may help optimize system resources by avoiding continuous polling of the current time 306A.

At 314, an operation for tuning the plurality of receiver devices 106 may be executed. In some aspects, each of the plurality of receiver devices 106 may configure one or more tuners (such as the tuner 108) that support the plurality of radio channels based on the schedule specified in the received signaling information. The tuner 108 may be associated with at least one of the first type of receiver 108A, the second type of receiver 108B, up to the Nth type of receiver 108N. In some cases, each type of receiver may have a single antenna or separate antennas for each type of frequency spectrum/band.

The circuitry 208 may configure the tuner 108 associated with at least one of the plurality of receiver devices 106, such as the receiver device 106A. In some aspects, the tuner 108 associated with the receiver device 106A may tune one or more of the types of receivers to support the plurality of radio channels. The plurality of radio channels may be associated with one or more radio transmission spectrums, which may include, but are not limited to, an Advanced Television Systems Committee (ATSC) spectrum, a Wi-Fi frequency band, or a Narrowband-Internet of Things (NB-IoT) band. In some cases, the radio transmission spectrums may include a combination of licensed and unlicensed spectrums.

In some embodiments, the plurality of receiver devices 106 may correspond to a plurality of televisions. The tuner 108 may include multiple types of receivers, such as the first type of receiver 108A and the second type of receiver 108B. For example, the first type of receiver 108A may be tuned for supporting reception of the radio channel with an ATSC 3.0 spectrum, while the second type of receiver 108B may be tuned for supporting reception of the radio channel with the NB-IoT band.

In some cases, a television may be configured to support reception of multiple spectrums, such as the ATSC 3.0 spectrum and the NB-IoT band, based on the schedule specified in the signaling information. For instance, the television may be tuned for reception of the ATSC 3.0 spectrum and the NB-IoT band at a specific time (e.g., 5 PM) as specified in the signaling information.

This flexible configuration allows the system 102 to adapt to various broadcasting scenarios and efficiently manage the distribution of media content across different platforms and device types. The ability to support multiple spectrums and configure tuners based on scheduled information enhances the system's capability to deliver high-quality media content to diverse receiver devices.

At 316, an operation for channel bonding may be executed. The circuitry 208 may be configured to perform, based on the signaling information, the channel bonding operation to combine the plurality of radio channels into the bonded channel. The plurality of radio channels may be associated with one or more radio transmission spectrums. In some aspects, the channel bonding operation may be performed to combine one or more radio transmission spectrums into a single logical transmission channel. The channel bonding may offer high-speed transmission of the media file by aggregating the bandwidth of multiple channels.

In some cases, when the media file corresponds to the combined single radio transmission spectrum, the channel bonding may employ packet-level splitting. This technique may involve dividing the media file into smaller packets and distributing these packets among a plurality of radio transmission spectrums. The split media file packets may be broadcasted over one or more radio transmission spectrums and later reassembled at the receiver device (for example, 106A to 106N) of the plurality of receiver devices 106 to reconstruct the complete media file. This approach may enhance transmission efficiency and provide robustness against channel impairments.

In other cases, the media file may correspond to the combined single radio transmission spectrum, where the combined single radio transmission spectrum may be considered as a large physical layer pipe of bandwidth. In such instances, the broadcast station 104 may be configured to transmit the media file as a whole over the bonded channel, potentially leveraging the increased capacity to transmit higher quality or larger media files.

In some embodiments, the channel bonding may be performed with a plurality of radio channels, such as the ATSC 3.0 spectrum and the NB-IoT band. For example, the circuitry 208 may combine the ATSC 3.0 spectrum and the NB-IoT band into the bonded channel for media file transmission. This combination may allow for the simultaneous utilization of both broadcast and cellular network capabilities. Furthermore, the receiver device, such as a television, may configure one or more tuners, for example, tuner 108 to support the reception of the radio channels with the ATSC 3.0 spectrum and the NB-IoT band, enabling seamless integration of these diverse transmission methods.

In some aspects, the channel bonding operation may dynamically adapt to different transmission scenarios based on the characteristics of the media file, available radio channels, and network conditions. This flexibility may allow for efficient utilization of the available spectrum, improved transmission speeds for various types of media content, and enhanced quality of service. The system 102 may employ adaptive algorithms to optimize the channel bonding configuration in real-time, considering factors such as channel quality, bandwidth requirements, and device capabilities.

At 318, an operation for media file transmission may be executed. The circuitry 208 may be configured to transmit the media file to the plurality of receiver devices 106 over the bonded channel, based on the schedule. In some aspects, the media file may be transmitted as a whole or segmented at the packet level for more efficient transmission.

When transmitting the whole media file, it may be sent over the bonded channel using at least one radio channel of the plurality of radio channels. In cases where the media file is segmented, the divided portions may be transmitted concurrently over the bonded channel using multiple radio channels. For instance, the media file may be segmented and transmitted over the bonded channel utilizing radio channels associated with various spectrums, such as the ATSC 3.0 spectrum and the NB-IoT band.

In some embodiments, the broadcast station 104 may transmit the whole media file by treating the bonded channel as a high-capacity physical layer pipe. This approach may allow the bonded channel to accommodate the entire media file at once and support its transmission, potentially improving overall throughput and reducing latency.

The schedule for transmission may correspond to specific times or time windows. For example, the schedule may indicate a transmission time of 5 PM or a transmission window between 5 PM and 6 PM. In such cases, the bonded channel may consist of one or more radio transmission spectrums, which may include, but are not limited to, the ATSC 3.0 spectrum, the NB-IoT band, and other available spectrums such as Wi-Fi or cellular bands. The circuitry 208 may then transmit the media file, potentially segmented at the packet level, to the plurality of receiver devices 106 at the scheduled time or within the scheduled window.

This adaptive approach to media file transmission allows the system 102 to dynamically respond to various scenarios, optimizing the use of available spectrum and ensuring efficient delivery of content to the receiver devices. The ability to transmit whole files or segment them at the packet level, combined with the use of multiple radio transmission spectrums, enhances the system's capability to handle different types and sizes of media files while adhering to the predetermined schedule. Furthermore, this flexibility may enable the system 102 to adapt to changing network conditions, prioritize certain types of content, or implement quality of service policies as needed.

In some aspects, the system 102 may employ advanced error correction and packet recovery techniques to ensure reliable transmission over the bonded channel. This may include forward error correction (FEC) coding, automatic repeat request (ARQ) mechanisms, or hybrid approaches that combine both techniques. These methods may help mitigate the effects of channel impairments and improve the overall robustness of the transmission process. Additionally, the system 102 may implement adaptive modulation and coding schemes that can adjust the transmission parameters based on the current channel conditions of each radio channel within the bonded channel. This dynamic adaptation may help maximize the throughput and reliability of the media file transmission, ensuring optimal performance across varying network conditions.

At 320, an operation for controlling one or more configured tuners may be executed. The circuitry 208 (or another circuitry of a receiver device such as the receiver device 106A) may be configured to dynamically control the one or more configured tuners (such as the tuner 108) to receive the media file over the bonded channel. The configured tuner 108 may be adaptively controlled to receive media files based on current network conditions and device capabilities. For example, the tuner 108 may be configured to receive the media file over bonded channel that combines the ATSC 3.0 spectrum and the NB-IoT band.

The system 102 may provide enhanced flexibility in how receiver devices obtain the media file. For instance, some receiver devices may use the bonded channel for high-speed reception, leveraging the increased bandwidth for 4K or 8K content, while other receiver devices may use individual channels based on receiver device capabilities, power constraints, or network conditions.

In some aspects, the system 102 may employ machine learning algorithms to predict optimal channel configurations and transmission parameters based on historical data and real-time network analytics. This predictive approach may further improve the efficiency of media file distribution by proactively adjusting system parameters to match anticipated network conditions and user demands.

In some embodiments, each receiver device may retrieve the media file from the origin server 104A over the bonded channel or via a channel associated with one or more radio transmission spectrums. For example, the broadcast station 104 may broadcast signaling information that includes a schedule for delivery, channel bonding information, and a Uniform Resource Locator (URL) to an origin server 104A that stores the media file. Each receiver device may then retrieve the media file stored at the origin server 104A over the bonded channel or via the channel associated with the one or more radio transmission spectrums. In some cases, the one or more radio transmission spectrums associated with the channel may include the ATSC spectrum, the Wi-Fi frequency band, or other licensed or unlicensed spectrums.

At 322, an operation for playback may be executed. Each receiver device may be configured to control playback of the received media file.

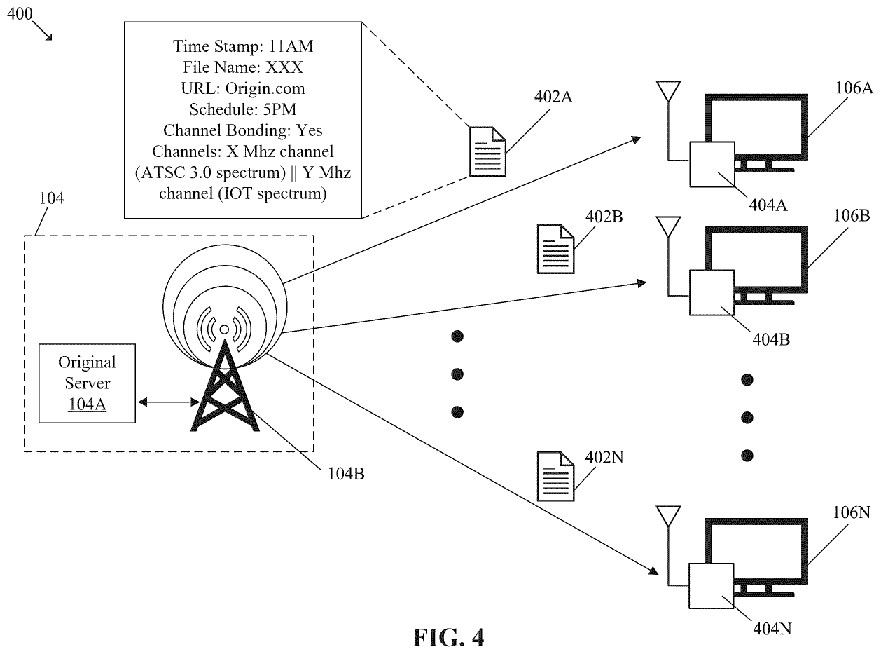

FIG. 4 is a diagram that illustrates an exemplary scenario for the delivery of media content based on a broadcasted schedule, in accordance with an embodiment of the disclosure. FIG. 4 is explained in conjunction with elements from FIGS. 1, 2, and 3. With reference to FIG. 4, there is shown a scenario 400. The scenario 400 includes the broadcast station 104 and the plurality of receiver devices 106. The broadcast station 104 includes the origin server 104A and the broadcast tower 104B.

In operation, the broadcast station 104 may transmit signaling information to the plurality of receiver devices 106, which may be televisions equipped with one or more tuners (such as 404A, 404B . . . 404N) and antennas for signal reception. The signaling information may be carried over a broadcast signal and may include various data elements such as a timestamp, file name, URL, delivery schedule, channel bonding information, and details about radio transmission spectrums associated with the radio channels.

For instance, the broadcast station 104 may transmit signaling information 402A to television 106A. The televisions (106A to 106N) may receive this information through their respective antennas and tuners (404A to 404N). Each television may then interpret the signaling information and configure its tuners to support reception across multiple radio channels. These channels may correspond to various radio transmission spectrums, including but not limited to ATSC spectrum, Wi-Fi frequency bands, or Narrowband-Internet of Things (NB-IoT) bands.

As an example, the signaling information 402A may specify a media file delivery schedule of 5 PM and indicate that channel bonding will utilize X MHz of the ATSC 3.0 spectrum and Y MHz of the IoT spectrum. In response, the television may configure one or more tuners (such as tuner 108 in FIG. 1) to receive the media file over the bonded channel at the scheduled time of 5 PM. The televisions (106A to 106N) may configure their tuners at 5 PM to support reception over the bonded channel, which may combine the ATSC 3.0 spectrum at a specific frequency (e.g., X MHz) and the IoT spectrum at another specific frequency (e.g., Y MHz).

To illustrate, consider a user of television 106A who wants to watch a high-definition video at 5 PM, requiring a high data rate for smooth playback. The system 102 may broadcast the signaling information 402A to television 106A, including the channel bonding schedule. The broadcast station 104 may determine the video delivery schedule for television 106A and broadcast the signaling information 402A specifying the 5 PM schedule. Based on the information, television 106A may tune the receiver (108A . . . 108N) to receive the video over the bonded channel at 5 PM. When the current time equals the scheduled time (T=ST), the broadcast station 104 may combine X MHz of the ATSC 3.0 spectrum and Y MHz of the IoT spectrum for channel bonding. The broadcast station 104 may then transmit the video to television 106A at 5 PM as scheduled. Television 106A may configure the tuner 108 to receive the video over the bonded channel and play it for the user.

The signaling information (402A to 402N) may be formatted for transmission using various standards, such as ATSC A/331 signaling format, PA-PPM signaling, or encapsulation into a bitstream or IP datagram.

It should be noted that the scenario 400 depicted in FIG. 4 is provided for illustrative purposes and should not be interpreted as limiting the scope of the disclosure. The system may be adapted to accommodate various transmission standards, receiver types, and scheduling requirements to optimize media content delivery in different contexts.

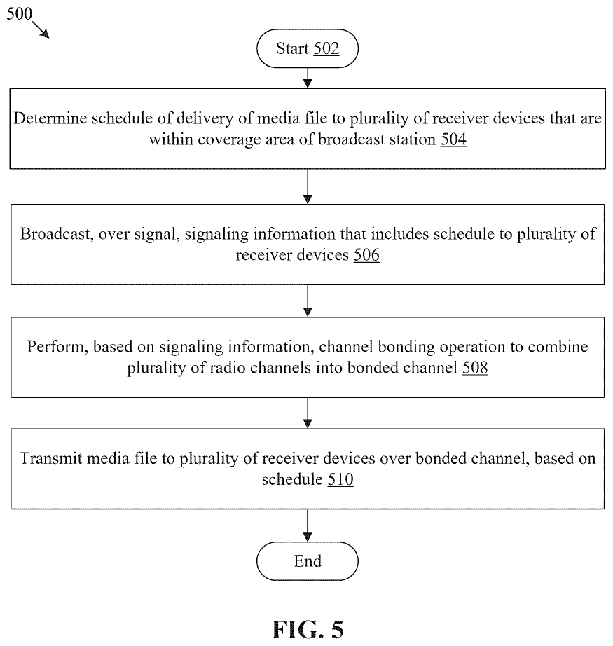

FIG. 5 illustrates a flowchart depicting operations of an exemplary method for schedule-based channel bonding for delivery of media content, in accordance with an embodiment of the disclosure. FIG. 5 is described in conjunction with elements from FIG. 1, FIG. 2, FIG. 3, and FIG. 4. With reference to FIG. 5, there is shown a flowchart 500. The flowchart 500 may include operations from 502 to 510 and may be implemented by the system 102 for broadcast station 104 of FIG. 1 or by the circuitry 208 of FIG. 2. The process may start at 502 and proceed sequentially through the operations.

At 504, the delivery schedule may be determined. The circuitry 208 may be configured to determine the schedule for delivery of the media file to the plurality of receiver devices 106 within the coverage area of the broadcast station 104. This determination may involve factors such as network traffic, available bandwidth, and receiver device capabilities. Details related to the delivery schedule determination are further described in FIG. 3 (at 302).

At 506, the signaling information may be broadcasted. The circuitry 208 may be configured to broadcast, over a signal, signaling information that includes the schedule to the plurality of receiver devices 106. The signaling information may be encoded and modulated to ensure reliable transmission across various channel conditions. Additional details related to the signaling information broadcasting are further described in FIG. 3 (at 304).

At 508, the channel bonding operation may be performed. Based on the signaling information, the circuitry 208 may be configured to execute a channel bonding operation to combine the plurality of radio channels into a bonded channel. The plurality of radio channels may be associated with one or more radio transmission spectrums, potentially including both licensed and unlicensed spectrums. Further details related to the channel bonding operation are described in FIG. 3 (at 306).

At 510, the media file may be transmitted. The circuitry 208 may be configured to transmit the media file to the plurality of receiver devices 106 over the bonded channel, based on the predetermined schedule. This transmission may utilize advanced error correction and adaptive modulation techniques to ensure efficient and reliable delivery of the media file. The system 102 may also implement quality of service policies as needed. Additional information related to the media file transmission is provided in FIG. 3 (at 308).

Although the flowchart 500 is illustrated as discrete operations, such as 502, 504, 506, 508, and 510, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (for example, a system 102 of FIG. 1) for a broadcast system (for example, a broadcast station 104 of FIG. 1). Such instructions may cause the broadcast station 104 to perform operations that may include determine a schedule of delivery of a media file to a plurality of receiver devices (for example, a plurality of receiver devices 106 of FIG. 1) that are within a coverage area of the broadcast station 104. The operations may further include broadcasting, over a signal, signaling information (for example, signaling information 402A, 402B, or 402N) that includes the schedule to the plurality of receiver devices 106. The operations may further include performing, based on the signaling information, a channel bonding operation to combine a plurality of radio channels into a bonded channel, wherein the plurality of radio channels is associated with one or more radio transmission spectrums. The operations may further include transmitting the media file to the plurality of receiver devices 106A over the bonded channel, based on the schedule.

Exemplary aspects of the disclosure may provide a system (for example, a system 102 of FIG. 1) for a broadcast system (for example, a broadcast station 104 of FIG. 1) that includes circuitry (such as, the circuitry 208). The circuitry 208 may be configured to determine a schedule of delivery of a media file to a plurality of receiver devices 106 that are within a coverage area (such as, the coverage area 408 in FIG. 4) of the broadcast station 104. The circuitry 208 may be configured to broadcast, over a signal, signaling information that includes the schedule to the plurality of receiver devices 106. The circuitry 208 may be configured to perform, based on the signaling information, a channel bonding operation to combine a plurality of radio channels into a bonded channel, wherein the plurality of radio channels is associated with one or more radio transmission spectrums. The circuitry 208 may be configured to transmit the media file to the plurality of receiver devices 106 over the bonded channel, based on the schedule.

In an embodiment, the circuitry 208 may be further configured to generate a Distribution Window Description (DWD) that includes the schedule, and wherein the signaling information includes the DWD.

In an embodiment, each receiver device of the plurality of receiver devices 106 may receive the signal that includes the signaling information and may configure, based on the schedule specified in the received signaling information, one or more tuners that support the plurality of radio channels. Further, controls the configured one or more tuners to receive the media file over the bonded channel.

In an embodiment, the signaling information further includes a Uniform Resource Locator (URL) to an origin server (for example, an origin server 104A) that stores the media file.

In an embodiment, each receiver device of the plurality of receiver devices 106 retrieves the media file from the origin server 104A over the bonded channel or via a channel associated with the one or more radio transmission spectrums.

In an embodiment, the one or more radio transmission spectrums include one or more of an Advanced Television Systems Committee (ATSC) spectrum, a Wi-Fi frequency band, or a Narrowband-Internet of Things (NB-IoT) band.

In an embodiment, the one or more radio transmission spectrums include a licensed spectrum and an unlicensed spectrum.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A system for a broadcast station, comprising:
circuitry configured to:
determine a schedule of delivery of a media file to a plurality of receiver devices that are within a coverage area of the broadcast station;
broadcast, over a signal, signaling information that includes the schedule to the plurality of receiver devices;
perform, based on the signaling information, a channel bonding operation to combine a plurality of radio channels into a bonded channel, wherein the plurality of radio channels is associated with one or more radio transmission spectrums; and
transmit the media file to the plurality of receiver devices over the bonded channel, based on the schedule.

2. The system according to claim 1, wherein the circuitry is further configured to generate a Distribution Window Description (DWD) that includes the schedule, and wherein the signaling information includes the DWD.

3. The system according to claim 1, wherein each receiver device of the plurality of receiver devices:
receives the signal that includes the signaling information;
configures, based on the schedule specified in the received signaling information, one or more tuners that support the plurality of radio channels; and
controls the configured one or more tuners to receive the media file over the bonded channel.

4. The system according to claim 1, wherein the signaling information further includes a Uniform Resource Locator (URL) to an origin server that stores the media file.

5. The system according to claim 4, wherein each receiver device of the plurality of receiver devices retrieves the media file from the origin server over the bonded channel or via a channel associated with the one or more radio transmission spectrums.

6. The system according to claim 1, wherein the one or more radio transmission spectrums include one or more of an Advanced Television Systems Committee (ATSC) spectrum, a Wi-Fi frequency band, or a Narrowband-Internet of Things (NB-IoT) band.

7. The system according to claim 1, wherein the one or more radio transmission spectrums include a licensed spectrum and an unlicensed spectrum.

8. A method, comprising:
in a system for a broadcast station:
determining a schedule of delivery of a media file to a plurality of receiver devices that are within a coverage area of the broadcast station;
broadcasting, over a signal, signaling information that includes the schedule to the plurality of receiver devices;
performing, based on the signaling information, a channel bonding operation to combine a plurality of radio channels into a bonded channel, wherein the plurality of radio channels is associated with one or more radio transmission spectrums; and
transmitting the media file to the plurality of receiver devices over the bonded channel, based on the schedule.

9. The method according to claim 8, further comprising generating a Distribution Window Description (DWD) that includes the schedule, wherein the signaling information includes the DWD.

10. The method according to claim 8, further comprising:
receiving, by each receiver device of the plurality of receiver devices, the signal that includes the signaling information;
configuring, by each receiver device of the plurality of receiver devices, one or more tuners that support the plurality of radio channels based on the schedule specified in the received signaling information; and
controlling the configured one or more tuners to receive the media file over the bonded channel.

11. The method according to claim 8, wherein the signaling information further includes a Uniform Resource Locator (URL) to an origin server that stores the media file.

12. The method according to claim 11, further comprising retrieving, by each receiver device of the plurality of receiver devices, the media file from the origin server over the bonded channel or via a channel associated with the one or more radio transmission spectrums.

13. The method according to claim 8, wherein the one or more radio transmission spectrums include one or more of an Advanced Television Systems Committee (ATSC) spectrum, a Wi-Fi frequency band, or a Narrowband-Internet of Things (NB-IoT) band.

14. The method according to claim 8, wherein the one or more radio transmission spectrums include a licensed spectrum and an unlicensed spectrum.

15. A non-transitory computer-readable medium having stored thereon, computer-executable instructions which, when executed by a system, cause the system to execute operations, the operations comprising:
determining a schedule of delivery of a media file to a plurality of receiver devices that are within a coverage area of the broadcast station;
broadcasting, over a signal, signaling information that includes the schedule to the plurality of receiver devices;
performing, based on the signaling information, a channel bonding operation to combine a plurality of radio channels into a bonded channel, wherein the plurality of radio channels is associated with one or more radio transmission spectrums; and
transmitting the media file to the plurality of receiver devices over the bonded channel, based on the schedule.

16. The non-transitory computer-readable medium according to claim 15, further comprising generating a Distribution Window Description (DWD) that includes the schedule, wherein the signaling information includes the DWD.

17. The non-transitory computer-readable medium according to claim 15, further comprising:
receiving, by each receiver device of the plurality of receiver devices, the signal that includes the signaling information;
configuring, by each receiver device of the plurality of receiver devices, one or more tuners that support the plurality of radio channels based on the schedule specified in the received signaling information; and
controlling the configured one or more tuners to receive the media file over the bonded channel.

18. The non-transitory computer-readable medium according to claim 15, wherein the signaling information further includes a Uniform Resource Locator (URL) to an origin server that stores the media file.

19. The non-transitory computer-readable medium according to claim 18, further comprising retrieving, by each receiver device of the plurality of receiver devices, the media file from the origin server over the bonded channel or via a channel associated with the one or more radio transmission spectrums.

20. The non-transitory computer-readable medium according to claim 15, wherein the one or more radio transmission spectrums include one or more of an Advanced Television Systems Committee (ATSC) spectrum, a Wi-Fi frequency band, or a Narrowband-Internet of Things (NB-IoT) band.
